(19) United States
(12) Patent Application Publication
(10) Pub. No.: US 2011/0139990 A1
(43) Pub. Date: Jun. 16, 2011

(54) MEMS-BASED FTIR SPECTROMETER

(75) Inventors: Huikai Xie, Gainesville, FL (US); Lei Wu, Gainesville, FL (US); Andrea Pais, Gainesville, FL (US); Sean Robert Samuelson, Gainesville, FL (US)

(73) Assignee: University of Florida Research Foundation, Inc., Gainesville, FL (US)

(21) Appl. No.: 12/989,871

(22) PCT Filed: Aug. 4, 2009
(86) PCT No.: PCT/US09/52705

§ 371 Date: Oct. 27, 2010

Related U.S. Application Data
(60) Provisional application No. 61/094,271, filed on Sep. 4, 2008.

(51) Int. Cl. G01N 21/35; G01J 3/45

(52) U.S. Cl. 250/353; 356/451

(57) ABSTRACT

A MEMS-based Fourier Transform (FT) spectrometer is provided. According to an embodiment, the MEMS-based FT spectrometer is an FT infrared (FTIR) spectrometer. The FT spectrometer can include a beam splitter positioned to receive an incoming beam from a light source and split the incoming beam into a first sub-beam and a second sub-beam, a fixed mirror positioned to receive the first sub-beam from the beam splitter, a scanning MEMS mirror positioned to receive the second sub-beam from the beam splitter, and a photodetector, wherein a reflected first sub-beam from the fixed mirror and a reflected second sub-beam from the scanning MEMS mirror recombine at the beam splitter and become directed to the photodetector. According to one embodiment, the photodetector is a MEMS-based IR detector. In addition, the MEMS-based IR detector can be an un-cooled IR detector having a capacitive sensing structure.

### CROSS-REFERENCE TO RELATED APPLICATION

The present application claims the benefit of U.S. Provisional Application Ser. No. 61/094,271, filed Sep. 4, 2008, which is hereby incorporated by reference herein in its entirety, including any figures, tables, or drawings.

The subject invention was made with government support from the National Science Foundation under Award No. 0901711. The government has certain rights in the invention.

### BACKGROUND OF INVENTION

Infrared spectroscopy can be used in chemical/biosensing for applications such as homeland security, environmental monitoring, food safety, and battlefields. Infrared spectroscopy, combined with a spectral library, can be used to quickly identify the presence of particular agents.

Infrared (IR) spectroscopy captures the molecular “fingerprints” of unknown substances. To accomplish this task, an IR light source is shined on an unknown substance. The IR energy from the IR light source interacts with the molecules of the substance. At this time, some of the IR energy is absorbed or transmitted through the substance, depending on the chemical bonds and functional groups that make up the object. Each functional group and bond is unique and, thus, creates a unique absorbance spectral pattern. Examination of the transmitted light can reveal how much energy is absorbed at each wavelength. By monitoring this absorbance spectral pattern, it is possible to link these different patterns to their corresponding functional groups and identify the composition of the object and/or the concentration of a particular compound or molecule. In addition to functional groups, hydrogen bonding, molecular conformations, and even chemical reactions can be determined by analyzing these absorption spectral patterns. The quantity of each component of a mixture may also be determined by observing the “peak” sizes of the absorbance patterns.

To obtain an IR spectrum, there are two typical approaches. One approach is to use a light source that outputs a monochromatic beam and changes in wavelength over time. The other approach is to use a broadband light source and a spectrometer or a dispersive component, such as a prism or a grating, to individually detect the wavelengths of the transmitted or reflected light. However, this can be a very slow process in case of wavelength sweeping. For the dispersive method, there is a serious tradeoff between the substance concentration resolution and the spectral resolution because the separation of the spectral components reduces the signal power of each spectral component. Therefore, as a recent improvement, IR spectroscopy utilizing a Fourier transform instrument, referred to as Fourier transform infrared (FTIR) spectroscopy, is being utilized. FTIR spectroscopy is a measurement technique where, instead of recording the amount of energy absorbed in each individual spectral range, the IR light including the entire spectra is collected by a single IR detector. Then, a mathematical Fourier transform is performed on the signal to provide a spectrum.

To accomplish FTIR spectroscopy, a Michelson interferometer can be used. A basic Michelson interferometer set-up is shown in FIG. 1. First, a light beam 10 is shined on a beam splitter 11, which may be a semi-transparent mirror. Half of the beam is reflected and directed toward a fixed mirror 12, and the other half is transmitted through and directed toward another mirror 13. In a conventional Michelson interferometer, this other mirror 13 also a fixed mirror. However, for the modified Michelson interferometer used for FTIR, this other mirror 13 is a moveable mirror. In certain systems, this mirror 13 is capable of moving a short distance of usually about a few millimeters. The beams eventually reflect from their mirrors and meet at the beam splitter 11, where the “sum” of the beams gets redirected to a detector 14.

The device works by using the interference resulting from the “sum” of the beams. If two light waves that superimpose are “in phase” with respect to each other, their amplitudes will add up and a constructive interference or maximum brightness will form. On the other hand if they are “out of phase,” destructive interference or minimum brightness will appear.

A complete, simple design of an FTIR is shown in FIG. 2. The source emits broadband infrared energy that is directed into the interferometer that functions as in FIG. 1. The beam that comes out of the interferometer goes into a sample compartment wherein the beam interacts with the given sample and is either transmitted through or reflected off of the surface of the sample, depending on the particular type of analysis in question. From this reflection and transmission, specific frequencies of energy are absorbed by the sample. After exiting the sample compartment, the beam reaches the detector and is measured to produce the interferogram signal. This signal gives the intensity of the energy absorbed as a function of time and position of the second mirror. Of interest are the aforementioned frequencies at which these “intensity peaks” or energy absorptions occur. The frequencies are “encoded” into the signal as the mirror moves. Consequently, by using the mathematical operation known as the Fourier transform to transform the time domain information from the interferogram to the frequency domain, the spectral information of the sample can be uncovered for analysis. The final aspect of the complete, simple FTIR is the inclusion of a laser for internal calibration of the device. This inclusion allows the system to be self-contained, barring the transforming of the interferogram.

Advantageously FTIR Spectroscopy can be used to identify different components quickly and sensitively. However, conventional FTIR spectrometers tend to be large and not portable. Thus, there exists a need in the art to provide a miniaturized FTIR instrument. A number of challenges exist for FTIR miniaturization, including addressing the bulky scanning mechanism and the bulky and expensive cooled IR detector.

Microelectromechanical systems (MEMS) technology has been proposed to miniaturize FTIR systems. MEMS-based FTIR systems using the Michelson Interferometer concept have been reported in the past using electrostatically actuated micromirrors. However, electrostatic comb-drive actuators suffer from high operating voltages and small displacement range. For example, Omar Manzardo et al., in their paper entitled “Miniaturized time-scanning Fourier transform spectrometer based on silicon technology,” (Optics Letters, Vol. 24, pp. 1705-1707, 1999) reported an FTIR system using a MEMS electrostatic comb-drive actuated micromirror. The mirror was 75 μm×500 μm in size and was capable of producing a maximum controllable displacement of 77 μm (voltage of ±10 V) resulting in a measured spectral resolution of 5.2 nm for laser light of wavelength 633 nm. Christian Solf et al., in their paper entitled “Miniaturized LIGA Fourier Transformation Spectrometer,” (Proceedings of IEEE, vol. 2, pp. 773-776, 2003) developed a Michelson Interferometer that consisted of an optical bench for the passive alignment of the optical components with an integrated electromechanical actuator. All parts such as the collimation optics, the detectors and the actuator were assembled on a chip. The system was manufactured using the LIGA technology. The electromechanical actuator was capable of producing a maximum controllable displacement of 60 μm. With this setup a maximum resolution of 24.5 nm was obtained. Later on, Thilo Sandner et al. from the Fraunhofer Institute for Photonic Microsystems proposed a miniaturized MEMS based FTIR spectrometer also using electrostatically actuated MEMS moving minors. (See Thilo Sandner et al., “Miniaturized FTIR-Spectrometer based on Optical MEMS Translatory Actuator,” Proc. of SPIE Vol. 6466, pp. 646602-1 646602-12, 2007). They were able to achieve a maximum displacement of 200 μm with their design at a voltage V=±40 V. The higher displacement was achieved at resonance and by placing the mirror in a vacuum chamber of 100 Pa, requiring expensive vacuum packaging and resonance operation. Still the stability and reliability of such largely-displaced MEMS structures in so high vacuum is a big concern. Furthermore, a Peltier cooled IR detector was used to detect the IR intensity. The mirror size was measured 1.5×1.1 mm². Kyoungsik Yu et al. in their paper entitled “Micromachined Fourier transform spectrometer on silicon optical bench platform,” (Sensors and Actuators A, 130-131 pp. 523-530, 2006), recently demonstrated a Micromachined Fourier transform spectrometer on silicon optical bench platform. All components except the IR detector including the silicon beam splitter, micromirrors, MEMS actuators, and fiber U-grooves, were simultaneously fabricated by micromachining of the device layer of a silicon-on-insulator wafer. This design relies on the thickness of the wafer for its sidewalls. They achieved a measured spectral resolution of 45 mn for near 1500 nm wavelength IR light. The maximum achievable mirror displacement was 25 μm. The entire size of the FTIR system was 4 mm×8 mm×0.6 mm.

As can be seen from the above examples, the main problem for MEMS-based FTIR is that the displacements of the MEMS mirrors are too small. In addition, there exists a need in the art for effective small-sized un-cooled IR detectors.

### BRIEF SUMMARY

Embodiments of the present invention relate to Fourier transform (FT) spectroscopy for chemical and biosensing applications to identify the presence of particular agents. According to an aspect of the present invention, a MEMS scanning micromirror is provided that is capable of moving in a millimeter range at hundreds of Hertz. In addition, according to another aspect of the present invention an un-cooled MEMS IR detector is provided having high sensitivity and only a few millimeter footprint.

According to an embodiment, a FT spectrometer is provided that includes an interferometer having a scanning MEMS-based micromirror. In a specific embodiment, the FT spectrometer is a Fourier transform infrared (FTIR) spectrometer. In a particular embodiment, the interferometer can be a modified Michelson interferometer where the scanning MEMS micromirror is used as a movable mirror to create interference. The FT spectrometer can include a beam splitter that splits an incoming beam (either from an IR source or transmitted through the sample) into two sub-beams and directs the sub-beams to a fixed mirror and a scanning MEMS mirror, respectively. The split beams reflect off of the fixed mirror and the scanning MEMS mirror and return through the beam splitter, where they recombine and are directed to a detector.

According to embodiments of the subject MEMS micromirror, the micromirror can generate about one millimeter of displacement. To accomplish such a displacement, large-vertical displacement (LVD) micro-actuators can be used to actuate the MEMS micromirror.

In a further embodiment, a MEMS-based un-cooled IR detector can be used as the detector of the subject FT spectrometer. In one embodiment, the MEMS-based un-cooled IR detector can include a lower electrode on a substrate, an upper electrode supported by LVD micro-actuators, and an IR absorber layer on the upper electrode. When infrared light is incident on the top IR absorber layer, the temperature increase on bimorph beams of the LVD actuators causes a downward bending motion, which can be transformed to a purely vertical motion of the upper electrode. The resultant capacitive change can be sensed by an integrated sensing circuit.

According to embodiments, a portable or wearable, high-resolution FTIR spectrometer can be provided.

### BRIEF DESCRIPTION OF DRAWINGS

FIG. 1 shows a schematic of a conventional Michelson Interferometer.

FIG. 2 shows a schematic of a simple design of a FTIR.

FIG. 3 shows a schematic of a miniature FTIR according to an embodiment of the invention.

FIG. 4 shows a MEMS micromirror having a large vertical displacement actuator according to an embodiment of the invention.

FIG. 5 shows a SEM photograph of a fabricated LSF-LVD micromirror according to an embodiment of the invention

FIG. 6 shows a schematic of a MEMS un-cooled IR detector according to an embodiment of the invention.

FIG. 7 shows a schematic of a bimorph structure for a MEMS un-cooled IR detector according to an embodiment of the invention.

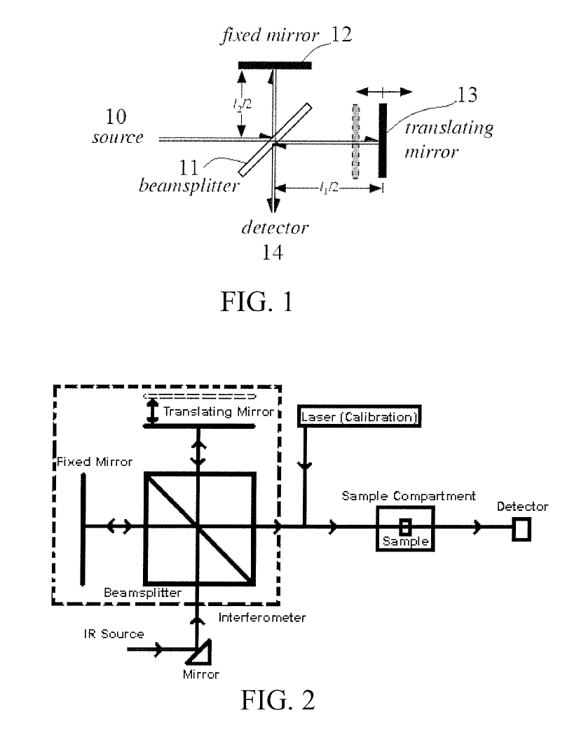

### DETAILED DISCLOSURE

The present invention relates to a miniaturized FT spectrometer. Embodiments of the subject FT spectrometer can be provided for a mobile platform. Implementations of the subject invention can include, but are not limited to, FTIR interferometers, IR detectors, FTIR spectrometers, gas sensors, chemical sensors, and biosensors.

According to an embodiment, the subject FT spectrometer can include a modified Michelson interferometer having one movable mirror. Accordingly, embodiments of the subject miniaturized FT spectrometer can include a fixed micromirror, a beam splitter, a photodetector, and a scanning MEMS micromirror. In certain embodiments, the photodetector can be a MEMS-based un-cooled IR detector.

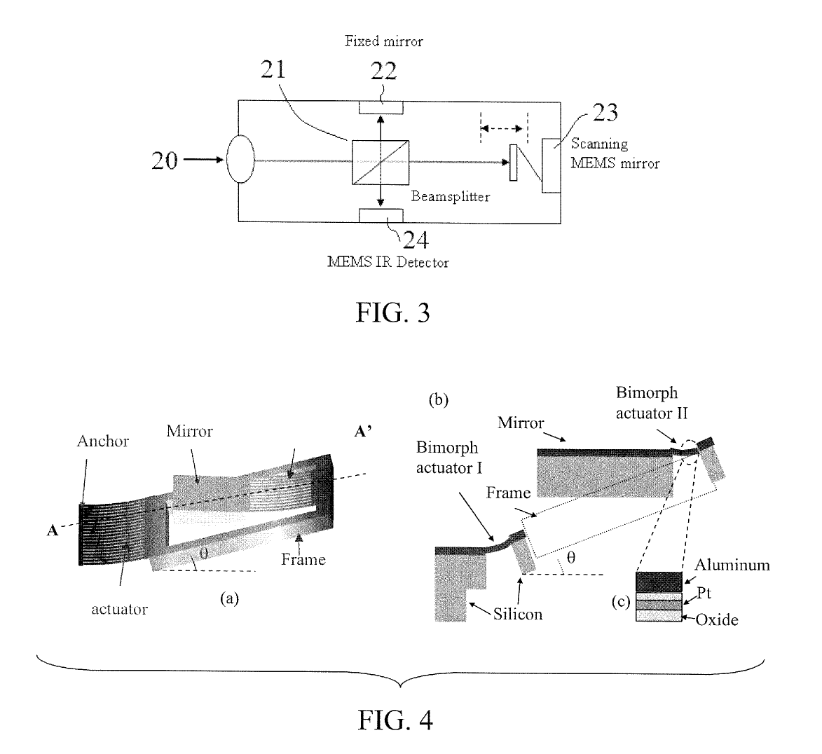

FIG. 3 shows a schematic representation of a FTIR spectrometer according to an embodiment of the present invention. Referring to FIG. 3, light 20 from an IR light source or transmitted through a sample can be shined on a beam splitter 21. Half of the beam is reflected and directed toward a fixed minor 22, and the other half is transmitted through and directed toward a scanning MEMS mirror 23. The beams eventually reflect from their minors and meet at the beam splitter 21, where the “sum” of the beams is redirected to a MEMS-based IR detector 24. The beam splitter 21, fixed mirror 22, scanning MEMS mirror 23, and MEMS-based IR detector can be provided as a packaged device.

In certain implementations, the dimensions of the packaged device can be on the order of 5 mm by 5 mm by 5 mm. In yet other implementations, the dimensions of the packaged device can be smaller.

Microelectromechanical systems (MEMS) are an emerging technology capable of miniaturizing a variety of systems. MEMS micromirrors have previously been used to miniaturize the Michelson interferometer. However, the wavelength resolution of an FTIR spectrometer is inversely proportional to the maximum scan length of the moving micromirror. Therefore, in order to achieve a high wavelength resolution, the maximum displacement of the MEMS micromirror has to be as large as possible. Currently, maximum displacements of most MEMS micromirrors are small, for example, only up to 50 μm, which would result in poor spectral resolutions. Accordingly, one issue when utilizing MEMS micromirrors for the movable mirror of the modified Michelson interferometer is the ability to provide the appropriate displacement. In accordance with certain embodiments of the present invention, the scanning MEMS mirror 23 can utilize large vertical displacement actuators to provide displacement of greater than 50 μm, and more particularly, greater than 250 μm.

Accordingly, embodiments of the subject FTIR spectrometer can utilize a large-vertical-displacement (LVD) microactuator that is capable of generating about one millimeter displacements with a device size of a few millimeters at hundreds of hertz. According to one embodiment, the MEMS micromirror for the FTIR spectrometer can utilize the LVD-actuated micromirror as shown in FIG. 4. The concept of a LVD microactuator is shown in FIG. 4. The bimorph actuators can be made of metal (e.g., Al) and dielectric (e.g, silicon dioxide) with an embedded heater (e.g., platinum resistor) (see inlaid detail FIG. 4(c)). The bimorph structures are thin-film and have large initial curling. Two bimorph structures can be used. One bimorph structure is connected to a frame, and the other to a mirror plate. An oppositely tilted frame is used to compensate the tilted minor, as shown in FIG. 4(b). Thus, the mirror plate stays flat but is elevated above the chip surface, which leaves space for large z-axis actuation. A 3D model of an example LVD mirror is shown in FIG. 4(a). The mirror plate is elevated above the chip surface plane. The height is equal to Lsin θ, where L is the length of the frame and θ is the initial tilt angle of the frame. As an example, if L=1.5 mm and θ=30°, the minor plate will be suspended about 750 μm above the substrate, but is still parallel to the chip surface.

When a current is applied to the heaters, temperature will increase and thus the bimorph structures will deform due to different thermal expansion coefficients of the metal and dielectric. The bimorph actuator I will rotate the frame clockwise, and the mirror will also rotate clockwise since it is connected to the frame. The bimorph actuator II will rotate the mirror counterclockwise. When proper currents are injected into both bimorph actuators, the clockwise rotation compensates the counterclockwise rotation, resulting in pure z-axis motion. For example, if L=3 mm and θ=45°, the z-displacement may be as much as 2.1 mm. Thus, a LVD micromirror operating at the z-axis actuation mode can be used as the scanning mirror in embodiments of the proposed FTIR system. In certain embodiments, the scanning minor used in the FTIR system can exhibit a vertical displacement of at least 200 μm.

Embodiments of the LVD-actuated micromirror can enable a new generation of miniature, high-resolution FTIR spectrometers that are portable, wearable and inexpensive.

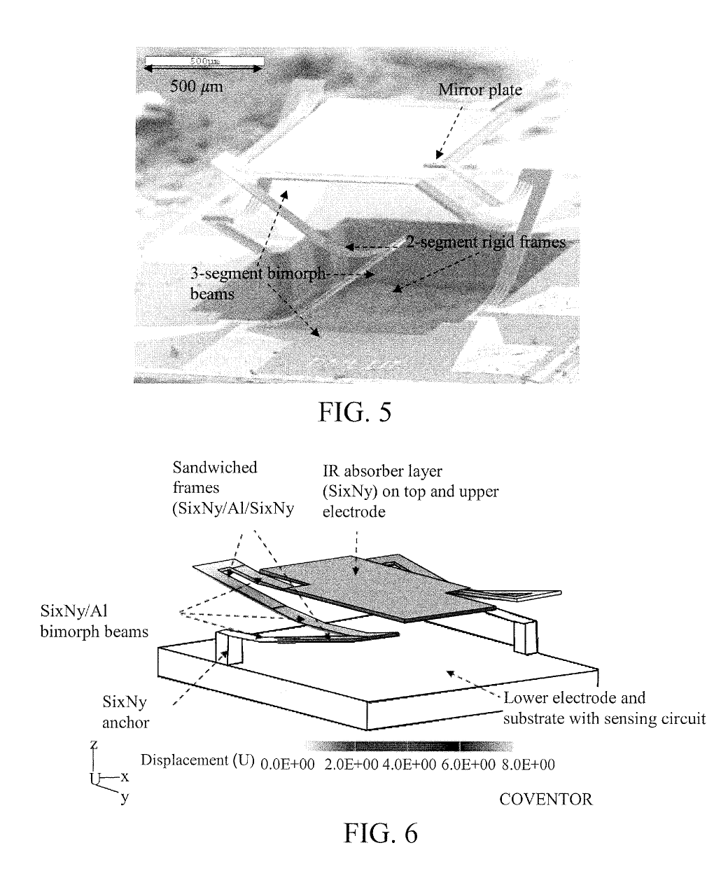

A scanning electron microscopic image of a LVD micromirror that can be used in an implementation of the subject FTIR spectrometer is shown in FIG. 5. Note that this micromirror utilizes the principle of LVD actuation but each actuator consists of three segments instead of two segments to compensate lateral shift. As shown in FIG. 5, the micromirror device foot print is about 2 mm by 2 mm, and the mirror plate is about 1 mm by 1 mm. With an 8 V voltage applied to the integrated actuators, the mirror plate of this particular micromirror can move nearly 1 mm. Its resonant frequency is about 300 Hz. (See paper entitled “A large vertical displacement electrothermal bimorph microactuator with very small lateral shift,” Sensors and Actuators A: Physical, Volumes 145-146, July-August 2008, Pages 371-379, by Lei Wu and Huikai Xie, which is hereby incorporated by reference in its entirety).

In addition, the type of IR detector used in the FTIR spectrometer can affect the characteristics of the FTIR spectrometer. There are two basic types of IR detectors. One type is a cooled IR detector, which is typically based on photon detection, and the other type is an un-cooled IR detector, which is based on thermal detection. The cooled IR detector requires a cooling system to increase resolution, but the cooling system not only increases the cost but also dramatically increases the size. The un-cooled IR detector can avoid the expense of cooling systems. However, current un-cooled IR detectors tend to have high power consumption and thermal resistive noise.

According to an embodiment of the present invention, a MEMS-based un-cooled IR detector is provided. The subject un-cooled IR detector can be inexpensive and still maintain high sensitivity and high resolution.

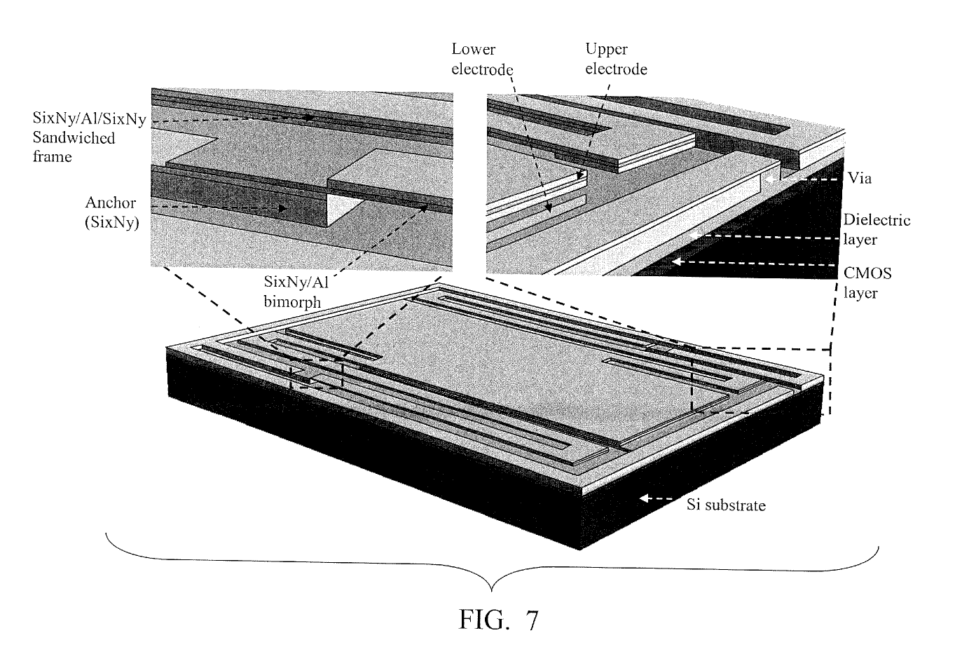

FIG. 6 shows a MEMS-based un-cooled IR detector according to an embodiment of the present invention. The subject un-cooled IR detector is based on a capacitive sensing structure. According to an implementation, the lower electrode is provided on the substrate and the upper electrode supported by two lateral-shift-free (LSF) large-vertical-displacement (LVD) bimorph actuators. When the infrared light is incident on the top IR absorber layer, the temperature increase on the bimorph beams will cause either an upward (SiₓN_{y}-on-top bimorph) or a downward (Al-on-top bimorph) bending motion, which can be transformed to a purely vertical motion of the upper electrode. The resultant capacitive change can be sensed by an integrated sensing circuit. In one embodiment, the IR absorber layer can be a SiₓN_{y} layer (where x and y are natural numbers) formed on top of the upper electrode. The bimorph beams can be provided as an aluminum layer with a SiₓN_{y} layer at one side thereof. Certain portions of the beams (referred to in FIG. 6 as sandwiched frames) can include a SiₓN_{y} layer on both sides of the aluminum layer. The bimorph beams can be anchored to the substrate using, for example a SiₓN_{y} anchor. The IR detector can be fabricated using a post-CMOS surface-micromachining process. FIG. 7 shows the structure details of the IR detector, the IR sensing structure can be electrically isolated from the bottom CMOS layer using a dielectric layer, for example, polyimide. Both the upper and lower electrodes are connected to CMOS sensing circuits through vias. The suspended structure of the upper electrode and its supporting bimorph beams can be formed using sacrificial layers such as SiO₂.

Embodiments of the disclosed MEMS IR detector can have one or more of the advantages of small size, low noise equivalent temperature difference (NETD), fast thermal response, and CMOS compatibility of its fabrication process.

An FTIR spectrometer according to one implementation can include a modified Michelson interferometer using a MEMS micromirror that utilizes a LVD microactuator, and a MEMS-based un-cooled IR detector having a capacitive sensing structure also utilizing LVD actuators.

By using such an implementation, an FTIR device can be provided having a small foot print (<1 cm in all dimensions). In addition, the FTIR device can be light weight (<100 grams). Accordingly, by being small and light weight, the FTIR device can be portable. Furthermore, embodiments can achieve low power consumption while providing fast measurements.

All patents, patent applications, provisional applications, and publications referred to or cited herein are incorporated by reference in their entirety, including all figures and tables, to the extent they are not inconsistent with the explicit teachings of this specification.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to utilize or combine such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

We claim:

1. A Fourier Transform spectrometer (FTS), comprising:
a beam splitter positioned to receive an incoming beam from a light source and split the incoming beam into a first sub-beam and a second sub-beam;
a fixed minor positioned to receive the first sub-beam from the beam splitter;
a scanning MEMS mirror comprising a large-vertical-displacement actuator, the scanning MEMS mirror positioned to receive the second sub-beam from the beam splitter; and
a photodetector, wherein a reflected first sub-beam from the fixed minor and a reflected second sub-beam from the scanning MEMS mirror recombine at the beam splitter and become directed to the photodetector.

2. The FTS according to claim 1, wherein the photodetector is a MEMS-based IR detector, wherein the light source is an IR light source.

3. The FTS according to claim 2, wherein the MEMS-based IR detector comprises:
a lower electrode provided on a substrate;
an upper electrode supported above the lower electrode by at least one vertical displacement actuator;
an IR absorber layer on the upper electrode, wherein IR light incident on the IR absorber layer creates a temperature increase and causes a vertical displacement of the at least one vertical displacement actuator, which causes the upper electrode supported by the at least one vertical displacement actuator to move, thereby resulting in a capacitive change; and
a sensing circuit on the substrate for sensing the capacitive change.

4. The FTS according to claim 3, wherein the at least one vertical displacement actuator comprises a lateral-shift-free large vertical displacement bimorph actuator.

5. The FTS according to claim 3, wherein the substrate comprises a silicon substrate.

6. The FTS according to claim 3, wherein the lower electrode and the upper electrode comprise aluminum.

7. The FTS according to claim 6, wherein the at least one vertical displacement actuator comprises two bimorph beams connected in an S configuration, the bimorph beams comprising an aluminum layer and SiₓN_{y} (where x and y represent the atomic ratio of Si and N).

8. The FTS according to claim 6, wherein the IR absorber layer comprises SiₓN_{y} where x and y represent the atomic ratio of Si and N.

9. The FTS according to claim 3, wherein the at least one vertical displacement actuator is arranged such that the temperature increase causes a downward vertical displacement of the at least one vertical displacement actuator, which causes the upper electrode supported by the at least one vertical displacement actuator to move downward.

10. The FTS according to claim 3, wherein the at least one vertical displacement actuator is arranged such that the temperature increase causes an upward vertical displacement of the at least one vertical displacement actuator, which causes the upper electrode supported by the at least one vertical displacement actuator to move upward.

11. The FTS according to claim 3, wherein the vertical displacement of the scanning MEMS mirror is at least 200 μm.
